(19) United States
(12) Patent Application Publication
(10) Pub. No.: US 2026/0346164 A1
(43) Pub. Date: Nov. 5, 2026

(54) FUEL OXYGEN REDUCTION UNIT WITH RECUPERATIVE HEAT EXCHANGER

(71) Applicant: General Electric Company, Evendale, OH (US)

(72) Inventors: Scott Gregory Edens, Milford, OH (US); Kevin Edward Hinderliter, Cincinnati, OH (US)

(21) Appl. No.: 19/745,141

(22) Filed: Jul. 17, 2026

Related U.S. Application Data
(62) Division of application No. 17/495,027, filed on Oct. 6, 2021.

(51) Int. Cl. B01D 19/00; B01J 8/00; B64D 37/30; B64D 37/32; F02C 7/22

(52) U.S. Cl. CPC B01D 19/0005; B01D 19/0042; B01J 8/001; B64D 37/30; B64D 37/32; F02C 7/22

(57) ABSTRACT

A fuel oxygen reduction unit is provided that includes an inlet fuel line and an outlet fuel line; an oxygen transfer assembly in fluid communication with the inlet fuel line, the outlet fuel line, and a stripping gas flowpath for reducing an amount of oxygen in an inlet fuel flow through the inlet fuel line using a stripping gas flow through the stripping gas flowpath; a catalyst in communication with the stripping gas flowpath at a location downstream of the oxygen transfer assembly, the catalyst configured to reduce an oxygen content of the stripping gas flow through the stripping gas flowpath; and a recuperative heat exchanger in airflow communication with the stripping gas flowpath at a location downstream of the catalyst and upstream of the catalyst for exchanging heat from the stripping gas flow flowing from the catalyst with the stripping gas flow flowing through the recuperative heat exchanger at the location upstream of the catalyst.

### CROSS-REFERENCE TO RELATED APPLICATIONS

This application is a divisional application of U.S. application Ser. No. 17/495,027, filed Oct. 6, 2021, which is hereby incorporated by reference in its entirety.

### FIELD

The present subject matter relates generally to a fuel oxygen reduction unit for an engine and a method of operating the same.

### BACKGROUND

Typical aircraft propulsion systems include one or more gas turbine engines. The gas turbine engines generally include a turbomachine, the turbomachine including, in serial flow order, a compressor section, a combustion section, a turbine section, and an exhaust section. In operation, air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Certain operations and systems of the gas turbine engines and aircraft may generate a relatively large amount of heat. Fuel has been determined to be an efficient heat sink to receive at least some of such heat during operations due at least in part to its heat capacity and an increased efficiency in combustion operations that may result from combusting higher temperature fuel.

However, heating the fuel up without properly conditioning the fuel may cause the fuel to “coke,” or form solid particles that may clog up certain components of the fuel system, such as the fuel nozzles. Reducing an amount of oxygen in the fuel may effectively reduce the likelihood that the fuel will coke beyond an unacceptable amount.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic, cross-sectional view of a gas turbine engine in accordance with an exemplary embodiment of the present disclosure.

FIG. 2 is a schematic view of a fuel oxygen reduction unit in accordance with an exemplary embodiment of the present disclosure.

FIG. 3 is a schematic view of a fuel oxygen reduction unit in accordance with an exemplary embodiment of the present disclosure.

FIG. 4 is a flow diagram of a method for operating a fuel delivery system in accordance with the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

In a fuel oxygen reduction unit of the present disclosure, an oxygen transfer assembly reduces an amount of oxygen in an inlet fuel flow through an inlet fuel line using a stripping gas flow through a stripping gas flowpath. In certain embodiments, a pre-heater may be in thermal communication with the stripping gas flowpath at a location downstream of the oxygen transfer assembly. The pre-heater is configured to receive and add heat energy to the stripping gas flow from the oxygen transfer assembly. A catalyst is in airflow communication with the stripping gas flowpath at a location downstream of the oxygen transfer assembly and the pre-heater, if included. The catalyst is configured to reduce an oxygen content of the the stripping gas flow through the stripping gas flowpath. The stripping gas flow from the catalyst may be referred to as a stripping gas stream. A recuperative heat exchanger is in airflow communication with the stripping gas flowpath at a location downstream of the catalyst and upstream of the catalyst. The heat exchanger is configured to take a portion of heat from the stripping gas stream from the catalyst for exchanging heat from the stripping gas flow from the catalyst with the stripping gas flow at the location upstream of the catalyst.

For example, the stripping gas flow may be configured to travel through the stripping gas flowpath from the oxygen transfer assembly, through the recuperative heat exchanger as a heat sink, through the catalyst, through the recuperative heat exchanger as a heat source, and back to the oxygen transfer assembly. It will be appreciated that such a flow arrangement is not exclusive of other intermediate components, such as a pre-heater if provided.

Advantageously, the stripping gas stream that flows from the heat exchanger to the oxygen transfer assembly has a lower temperature because the heat exchanger takes a portion of the heat from the stripping gas stream. Furthermore, the heat exchanger of the present disclosure ensures a lower amount of energy is required from the pre-heater to heat the stripping gas flow that flows from the heat exchanger to the pre-heater and subsequently to the catalyst.

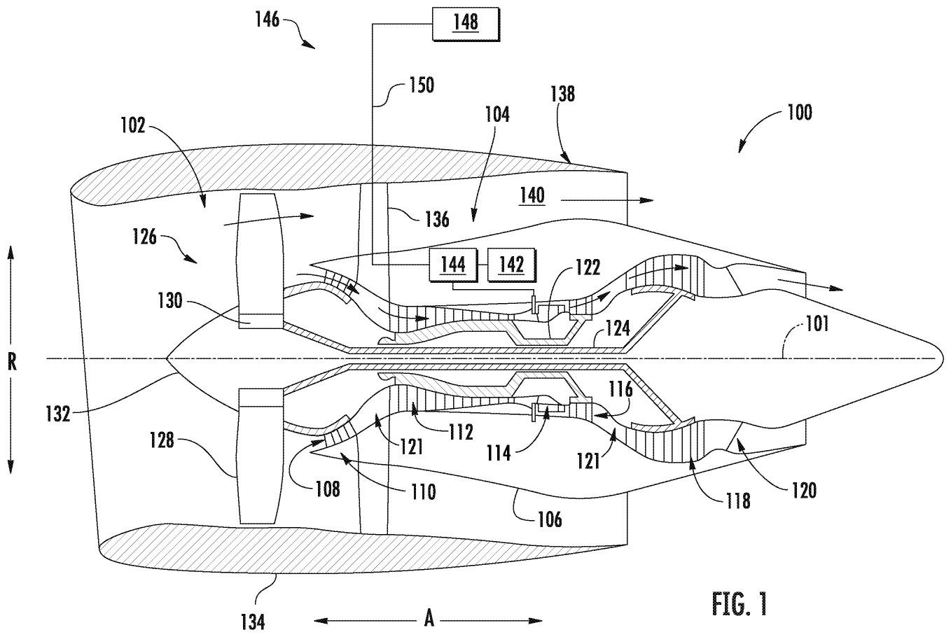

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable aircraft.

For the embodiment depicted, the engine is configured as a high bypass turbofan engine 100. As shown in FIG. 1, the turbofan engine 100 defines an axial direction A (extending parallel to a longitudinal centerline or axis 101 provided for reference), a radial direction R, and a circumferential direction (extending about the axial direction A; not depicted in FIG. 1). In general, the turbofan 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet exhaust nozzle section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The plurality of fan blades 128 and disk 130 are together rotatable about the longitudinal axis 101 by the LP shaft 124. The disk 130 is covered by rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The outer nacelle 134 is supported relative to the turbomachine 104 by a plurality of circumferentially-spaced outlet guide vanes 136. A downstream section 138 of the outer nacelle 134 extends over an outer portion of the turbomachine 104 so as to define a bypass airflow passage 140 therebetween.

Referring still to FIG. 1, the turbofan engine 100 additionally includes an accessory gearbox 142, a fuel oxygen reduction unit 144, and a fuel delivery system 146. For the embodiment shown, the accessory gearbox 142 is located within the cowling/outer casing 106 of the turbomachine 104. Additionally, it will be appreciated that, although not depicted schematically in FIG. 1, the accessory gearbox 142 may be mechanically coupled to, and rotatable with, one or more shafts or spools of the turbomachine 104. For example, in at least certain exemplary embodiments, the accessory gearbox 142 may be mechanically coupled to, and rotatable with, the HP shaft 122. Further, for the embodiment shown, the fuel oxygen reduction unit 144 is coupled to, or otherwise rotatable with, the accessory gearbox 142, although in other embodiments the fuel oxygen reduction unit 144 may use other, or additional sources, of rotary power such as an electric motor. In such a manner, it will be appreciated that the exemplary fuel oxygen reduction unit 144 is driven by the accessory gearbox 142. Notably, as used herein, the term “fuel oxygen conversion or reduction” generally means a device capable of reducing a free oxygen content of the fuel.

Moreover, the fuel delivery system 146 generally includes a fuel source 148, such as a fuel tank, and one or more fuel lines 150. The one or more fuel lines 150 provide a fuel flow through the fuel delivery system 146 to the combustion section 114 of the turbomachine 104 of the turbofan engine 100.

It will be appreciated, however, that the exemplary turbofan engine 100 depicted in FIG. 1 is provided by way of example only. In other exemplary embodiments, any other suitable engine may be utilized with aspects of the present disclosure. For example, in other embodiments, the engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine 100, in other embodiments, a gas turbine engine of the present disclosure may be a geared gas turbine engine (i.e., including a gearbox between the fan 126 and shaft driving the fan, such as the LP shaft 124), may be a variable pitch gas turbine engine (i.e., including the fan 126 having the plurality of fan blades 128 rotatable about their respective pitch axes), etc. Further, although not depicted herein, in other embodiments the gas turbine engine may be any other suitable type of gas turbine engine, such as an industrial gas turbine engine incorporated into a power generation system, a nautical gas turbine engine, etc. Further, still, in alternative embodiments, aspects of the present disclosure may be incorporated into, or otherwise utilized with, any other type of engine, such as reciprocating engines.

Moreover, it will be appreciated that although for the embodiment depicted, the turbofan engine 100 includes the fuel oxygen reduction unit 144 positioned within the turbomachine 104, i.e., within the outer casing 106 of the turbomachine 104, in other embodiments, the fuel oxygen reduction unit 144 may be positioned at any other suitable location. For example, in other embodiments, the fuel oxygen reduction unit 144 may instead be positioned remote from the turbofan engine 100. Additionally, in other embodiments, the fuel oxygen reduction unit 144 may additionally or alternatively be driven by other suitable power sources such as an electric motor, a hydraulic motor, or an independent mechanical coupling to the HP or LP shaft, etc.

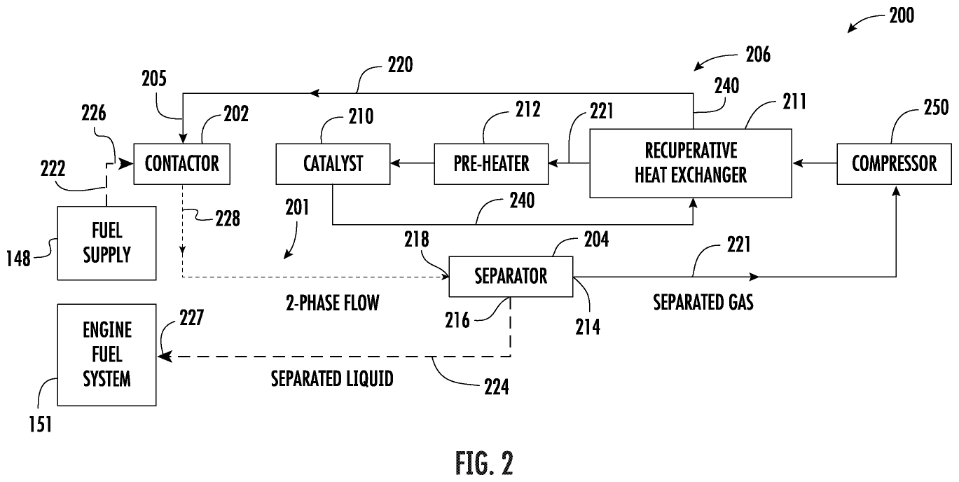

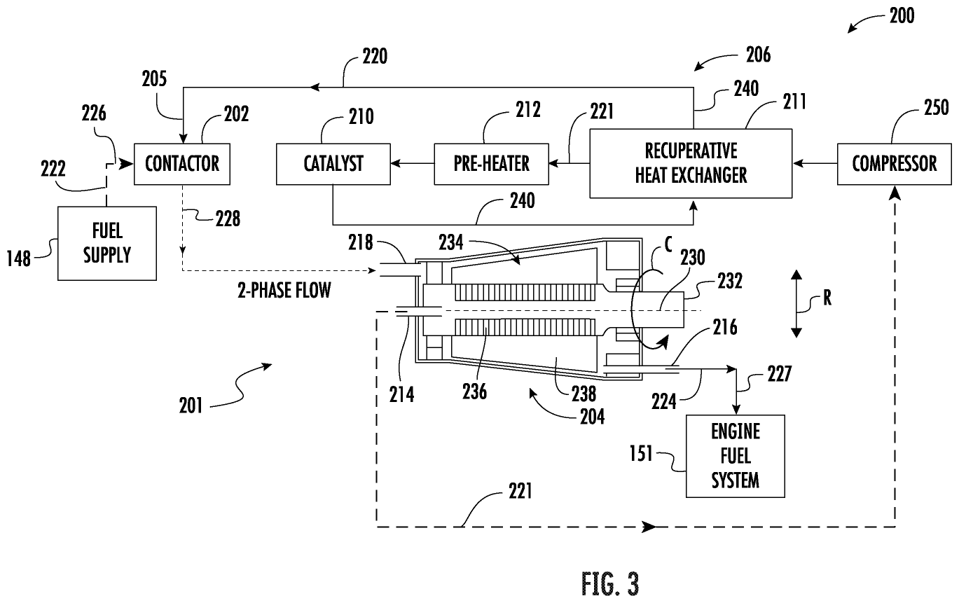

Referring now to FIGS. 2 and 3, schematic drawings of a fuel oxygen reduction unit 200 for a gas turbine engine in accordance with an exemplary aspect of the present disclosure is provided. In at least certain exemplary embodiments, the exemplary fuel oxygen reduction unit 200 depicted may be incorporated into, e.g., the exemplary engine 100 described above with reference to FIG. 1 (e.g., may be the fuel oxygen reduction unit 144 depicted in FIG. 1 and described above).

As will be appreciated from the discussion herein, in an exemplary embodiment, the fuel oxygen reduction unit 200 generally includes an oxygen transfer assembly 201. As will be explained in more detail, below, the oxygen transfer assembly 201 generally includes a contactor 202 and a separator 204. Further, the fuel oxygen reduction unit 200 additionally includes a catalyst 210, and a recuperative heat exchanger 211, and for the embodiment depicted, a pre-heater 212. In the exemplary embodiment depicted, the separator 204 is a dual separator pump as described in more detail below and as shown in FIG. 3.

It will be appreciated, however, that in other exemplary embodiments, other separators may be utilized with the fuel oxygen reduction unit 200 of the present disclosure. It will further be appreciated that in other exemplary embodiments, the oxygen transfer assembly 201 may additionally or alternatively include a membrane meant to filter or suck out the oxygen from the fuel into the stripping gas, or chemically react with the oxygen in the fuel to reduce the oxygen in the fuel. In such embodiments, the oxygen transfer assembly 201 may not include a contactor and a separator.

The oxygen transfer assembly 201 reduces an amount of oxygen in an inlet fuel flow 226 through an inlet fuel line 222 using a stripping gas flow 220 through a stripping gas flowpath 206 as described herein.

The pre-heater 212 is in thermal communication with the stripping gas flowpath 206 at a location downstream of the oxygen transfer assembly 201, e.g., at a location downstream of the contactor 202 and the separator 204, and upstream of the catalyst 210. The pre-heater 212 is configured to add heat energy to the stripping gas flow 220 that flows from the oxygen transfer assembly 201, e.g., an outlet stripping gas flow 221.

The catalyst 210 is in airflow communication with the stripping gas flowpath 206 at a location downstream of the oxygen transfer assembly 201, e.g., at a location downstream of the contactor 202 and the separator 204, and the pre-heater 212. The catalyst 210 is configured to receive and treat the outlet stripping gas flow 221 from the pre-heater 212. The catalyst 210 more specifically is configured to reduce an oxygen content of the stripping gas flow 220 through the stripping gas flowpath 206. The stripping gas flow 220 from the catalyst 210 may be referred to as a stripping gas stream 240.

The recuperative heat exchanger 211 is in airflow communication with the stripping gas flowpath 206 at a location downstream of the catalyst 210 and upstream of the catalyst 210. More specifically, in the exemplary embodiment depicted, the recuperative heat exchanger 211 is in airflow communication with the stripping gas flowpath 206 at a location downstream of the catalyst 210 and upstream of the pre-heater 212. The recuperative heat exchanger 211 is configured to take a portion of heat from the stripping gas stream 240 to heat the outlet stripping gas flow 221 before entering the pre-heater 212 and catalyst 210.

More specifically, it will be appreciated that the recuperative heat exchanger 211 is generally configured as an air-to-air heat exchanger defining a heat sink path (or rather a heat sink airflow path) and a heat source path (or rather a heat source airflow path). The recuperative heat exchanger 211 is configured to transfer heat from an airflow through the heat source path to an airflow through the heat sink path. In the embodiment depicted, the outlet stripping gas flow 221 from the oxygen transfer assembly 201 to the catalyst 210 is provided through the heat sink path as a heat sink, and the stripping gas flow 220 from the catalyst 210 to the oxygen transfer assembly 201 is provided through the heat source path as a heat source. In such a manner, the recuperative heat exchanger 211 is configured to transfer heat from the stripping gas flow 220 from the catalyst 210 to the oxygen transfer assembly 201 to the stripping gas flow 220 from the oxygen transfer assembly 201 to the catalyst 210. Such may result in warmer stripping gas flow 221 provided to the catalyst 210 and cooler stripping gas flow 220 provided to the oxygen transfer assembly 201.

Advantageously, the stripping gas stream 240 that flows from the recuperative heat exchanger 211 to the oxygen transfer assembly 201, e.g., the contactor 202, has a lower temperature (e.g., lower than it otherwise would be without the recuperative heat exchanger 211) because the recuperative heat exchanger 211 takes a portion of the heat from the stripping gas stream 240. Furthermore, the recuperative heat exchanger 211 of the present disclosure ensures a lower amount of energy is required from the pre-heater 212 to heat the outlet stripping gas flow 221 that flows from the recuperative heat exchanger 211 to the pre-heater 212.

In a fuel oxygen reduction unit 200 of the present disclosure, the catalyst 210 receives and treats the outlet stripping gas flow 221 that flows out of the separator 204 to reduce an oxygen content of the stripping gas flow 220 in order to reuse the stripping gas flow 220.

The exemplary contactor 202 depicted may be configured in any suitable manner to substantially mix a received stripping gas flow 220 and an inlet fuel flow 226, as will be described below. For example, the contactor 202 may, in certain embodiments be a mechanically driven contactor (e.g., having paddles for mixing the received flows), or alternatively may be a passive contactor for mixing the received flows 220, 226 using, at least in part, a pressure and/or flowrate of the received flows 220, 226. For example, a passive contactor may include one or more turbulators, a venturi mixer, etc.

Moreover, the exemplary stripping gas flowpath 206 of the fuel oxygen reduction unit 200 includes a stripping gas line 205, and more particularly, includes a plurality of stripping gas lines 205, which together at least in part define the stripping gas flowpath 206 extending from the separator 204 to the contactor 202. In certain exemplary embodiments, the stripping gas flowpath 206 may be formed of any combination of one or more conduits, tubes, pipes, etc. in addition to the plurality stripping gas lines 205 and structures or components within the stripping gas flowpath 206.

As will be explained in greater detail, below, the fuel oxygen reduction unit 200 generally provides for the stripping gas flow 220 through the plurality of stripping gas lines 205 and stripping gas flowpath 206 during operation. It will be appreciated that the term “stripping gas” is used herein as a term of convenience to refer to a gas generally capable of performing the functions described herein. The stripping gas flow 220 flowing through the stripping gas flowpath/circulation gas flowpath 206 may be an actual stripping gas functioning to strip oxygen from the fuel within the contactor, or alternatively may be a sparging gas bubbled through a liquid fuel to reduce an oxygen content of such fuel. For example, as will be discussed in greater detail below, the stripping gas flow 220 may be an inert gas, such as Nitrogen or Carbon Dioxide (CO₂), a gas mixture made up of at least 50% by mass inert gas, or some other gas or gas mixture having a relatively low oxygen content.

Referring specifically to FIG. 2, in an exemplary embodiment, the fuel oxygen reduction unit 200 includes a compressor 250 that is in airflow communication with the stripping gas flowpath 206 at a location downstream of the oxygen transfer assembly 201, e.g., at a location downstream of the contactor 202 and the separator 204, and upstream of the recuperative heat exchanger 211. The compressor is generally configured to increase a pressure of the stripping gas flow 220 to provide for the flow of the stripping gas flow 220 through the stripping gas flowpath 206. The compressor 250 may be configured as a pump or the like. It is also contemplated that other pumps, gas boost pumps, or similar components may be used in the fuel oxygen reduction unit 200 to increase a pressure of the stripping gas flow 220.

Referring now to FIG. 3, the fuel oxygen reduction unit 200 of FIG. 2 is depicted providing a more detailed schematic view of the separator 204. In the exemplary embodiment depicted, the separator 204 generally includes the stripping gas outlet 214, a fuel outlet 216, and an inlet 218. It will also be appreciated that the exemplary fuel oxygen reduction unit 200 depicted is operable with a fuel delivery system, such as the fuel delivery system 146 of the gas turbine engine including the fuel oxygen reduction unit 200 or an engine fuel system 151 (see, e.g., FIGS. 1 and 2). The exemplary fuel delivery system 146 generally includes a plurality of fuel lines, and in particular, the inlet fuel line 222 and an outlet fuel line 224. The inlet fuel line 222 is fluidly connected to the contactor 202 for providing the inlet fuel flow 226 (the flow of liquid fuel) to the contactor 202 (e.g., from the fuel source 148, such as a fuel tank; see FIG. 1) and the outlet fuel line 224 is fluidly connected to the fuel outlet 216 of the separator 204 for providing a flow of deoxygenated liquid fuel or outlet fuel flow 227 to the engine fuel system 151.

Generally, it will be appreciated that during operation of the fuel oxygen reduction unit 200, the inlet fuel flow 226 provided through the inlet fuel line 222 to the contactor 202 may have a relatively high oxygen content. The stripping gas flow 220 provided to the contactor 202 may have a relatively low oxygen content or other specific chemical structure. Within the contactor 202, the inlet fuel flow 226 is mixed with the stripping gas flow 220, resulting in a fuel/gas mixture 228. As a result of such mixing a physical exchange may occur whereby at least a portion of the oxygen within the inlet fuel flow 226 is transferred to the stripping gas flow 220, such that the fuel component of the fuel/gas mixture 228 has a relatively low oxygen content (as compared to the inlet fuel flow 226 provided through the inlet fuel line 222) and the stripping gas component of the fuel/gas mixture 228 has a relatively high oxygen content (as compared to the stripping gas flow 220 provided through the stripping gas flowpath 206 to the contactor 202).

Within the separator 204 the relatively high oxygen content stripping gas flow 220 is then separated from the relatively low oxygen content fuel flow 226 back into respective flows of an outlet stripping gas flow (the stripping gas flow 220 provided back to the stripping gas flowpath 206 from the separator 204) and outlet fuel 227.

As previously stated, in one exemplary embodiment, the separator 204 is a dual separator pump as shown in FIG. 3. For example, the dual separator pump defines a central axis 230, radial direction R, and a circumferential direction C extending about the central axis 230. Additionally, the dual separator pump is configured as a mechanically-driven dual separator pump, or more specifically as a rotary/centrifugal dual separator pump. Accordingly, the dual separator pump includes an input shaft 232 and a single-stage separator/pump assembly 234. The input shaft 232 is mechanically coupled to the single-stage separator/pump assembly 234, and the two components are together rotatable about the central axis 230. Further, the input shaft 232 may be mechanically coupled to, and driven by, e.g., an accessory gearbox (such as the exemplary accessory gearbox 142 of FIG. 1). However, in other embodiments, the input shaft 232 may be mechanically coupled to any other suitable power source, such as an electric motor. As will be appreciated, the single-stage separator/pump assembly 234 may simultaneously separate the fuel/gas mixture 228 into flows of the outlet stripping gas flow 221 and outlet fuel 227 and increase a pressure of the separated outlet fuel 227 (as will be discussed in greater detail below).

Additionally, the exemplary single-stage separator/pump assembly 234 depicted generally includes an inner gas filter 236 arranged along the central axis 230, and a plurality of paddles 238 positioned outward of the inner gas filter 236 along the radial direction R. During operation, a rotation of the single-stage separator/pump assembly 234 about the central axis 230, and more specifically, a rotation of the plurality of paddles 238 about the central axis 230 (i.e., in the circumferential direction C), may generally force heavier liquid fuel flow 226 outward along the radial direction R and lighter stripping gas flow 220 inward along the radial direction R through the inner gas filter 236. In such a manner, the outlet fuel 227 may exit through the fuel outlet 216 of the dual separator pump and the outlet stripping gas flow 221 may exit through the stripping gas outlet 214 of the dual separator pump, as is indicated.

Further, it will be appreciated that with such a configuration, the outlet fuel 227 exiting the dual separator pump through the fuel outlet 216 may be at a higher pressure than the inlet fuel flow 226 provided through the inlet fuel line 222, and further higher than the fuel/gas mixture 228 provided through the inlet 218. Such may be due at least in part to the centrifugal force exerted on such liquid fuel flow 226 and the rotation of the plurality of paddles 238. Additionally, it will be appreciated that for the embodiment depicted, the fuel outlet 216 is positioned outward of the inlet 218 (i.e., the fuel gas mixture inlet) along the radial direction R. Such may also assist with the increasing of the pressure of the outlet fuel 227 provided through the fuel outlet 216 of the separator 204.

For example, it will be appreciated that with such an exemplary embodiment, the separator 204 of the fuel oxygen reduction unit 200 may generate a pressure rise in the fuel flow during operation. As used herein, the term “pressure rise” refers to a net pressure differential between a pressure of the flow of outlet fuel 227 provided to the fuel outlet 216 of the separator 204 (i.e., a “liquid fuel outlet pressure”) and a pressure of the inlet fuel flow 226 provided through the inlet fuel line 222 to the contactor 202. In at least certain exemplary embodiments, the pressure rise of the liquid fuel flow 226 may be at least about sixty (60) pounds per square inch (“psi”), such as at least about ninety (90) psi, such as at least about one hundred (100) psi, such as up to about seven hundred and fifty (750) psi. With such a configuration, it will be appreciated that in at least certain exemplary embodiments of the present disclosure, the liquid fuel outlet pressure may be at least about seventy (70) psi during operation. For example, in at least certain exemplary embodiments, the liquid fuel out of pressure may be at least about one hundred (100) psi during operation, such as at least about one hundred and twenty-five (125) psi during operation, such as up to about eight hundred (800) psi during operation.

Further, it will be appreciated that the outlet fuel 227 provided to the fuel outlet 216, having interacted with the stripping gas flow 220, may have a relatively low oxygen content, such that a relatively high amount of heat may be added thereto with a reduced risk of the fuel coking (i.e., chemically reacting to form solid particles which may clog up or otherwise damage components within the fuel flow path). For example, in at least certain exemplary aspects, the outlet fuel 227 provided to the fuel outlet 216 may have an oxygen content of less than about five (5) parts per million (“ppm”), such as less than about three (3) ppm, such as less than about two (2) ppm, such as less than about one (1) ppm, such as less than about 0.5 ppm.

Moreover, as will be appreciated, the exemplary fuel oxygen reduction unit 200 depicted recirculates and reuses the stripping gas flow 220 (i.e., the stripping gas flow 220 operates in a substantially closed loop). However, the outlet stripping gas flow 221 exiting the separator 204, having interacted with the liquid fuel flow 226, has a relatively high oxygen content. Accordingly, in order to reuse the stripping gas flow 220, an oxygen content of the outlet stripping gas flow 221 from the stripping gas outlet 214 of the separator 204 needs to be reduced. For the embodiment depicted, and as noted above, the outlet stripping gas flow 221 flows through the pre-heater 212, through the catalyst 210 where the oxygen content of the stripping gas flow 220 is reduced, and through the recuperative heat exchanger 211 as described in detail above. More specifically, within the catalyst 210 the relatively oxygen-rich outlet stripping gas flow 221 is reacted to reduce the oxygen content thereof. It will be appreciated that catalyst 210 may be configured in any suitable manner to perform such functions. For example, in certain embodiments, the catalyst 210 may be configured to combust the relatively oxygen-rich outlet stripping gas flow 221 to reduce an oxygen content thereof. However, in other embodiments, the catalyst 210 may additionally, or alternatively, include geometries of catalytic components through which the relatively oxygen-rich outlet stripping gas flow 221 flows to reduce an oxygen content thereof. In one or more of these embodiments, the catalyst 210 may be configured to reduce an oxygen content of the outlet stripping gas flow 221 to less than about five percent (5%) oxygen (O2) by mass, such less than about two (2) percent (3%) oxygen (O2) by mass, such less than about one percent (1%) oxygen (O2) by mass.

As described herein, a catalyst 210 is disposed downstream of the separator 204 and the pre-heater 212, and the catalyst 210 receives and treats the outlet stripping gas flow 221 that flows out the pre-heater 212 and the stripping gas outlet 214 of the separator 204. In an exemplary embodiment, the catalyst 210 removes oxygen from the outlet stripping gas flow by chemically converting the oxygen in the outlet stripping gas flow into a water vapor and a carbon dioxide in the outlet stripping gas flow 221. Next, the outlet stripping gas flow 221 flows out of the catalyst 210 and to the recuperative heat exchanger 211 of the present disclosure as described herein.

The resulting relatively low oxygen content gas, e.g., the stripping gas stream 240 that flows from the recuperative heat exchanger 211 to the contactor 202 of the oxygen transfer assembly 201 and has a lower temperature because the recuperative heat exchanger 211 takes a portion of the heat from the stripping gas stream 240, is then provided through the remainder of the stripping gas flowpath 206 and back to the contactor 202, such that the cycle may be repeated.

In such a manner, it will be appreciated that the stripping gas flow 220 may be any suitable gas capable of undergoing the chemical transitions described above. For example, the stripping gas may be air from, e.g., a core air flowpath of a gas turbine engine including the fuel oxygen reduction unit 200 (e.g., compressed air bled from the HP compressor 112; see FIG. 1). However, in other embodiments, the stripping gas may instead be any other suitable gas, such as an inert gas, such as Nitrogen or Carbon Dioxide (CO₂), a gas mixture made up of at least 50% by mass inert gas, or some other gas or gas mixture having a relatively low oxygen content.

It will be appreciated, however, that the exemplary fuel oxygen reduction unit 200 described above is provided by way of example only. In other embodiments, the fuel oxygen reduction unit 200 may be configured in any other suitable manner.

In other embodiments, the stripping gas flow 220 may not flow through a stripping gas flowpath 206, and instead the fuel oxygen reduction unit 200 may include an open loop stripping gas flowpath, with such flowpath in flow communication with a suitable stripping gas source, such as a bleed air source, and configured to dump such air to the atmosphere downstream of the separator 204.

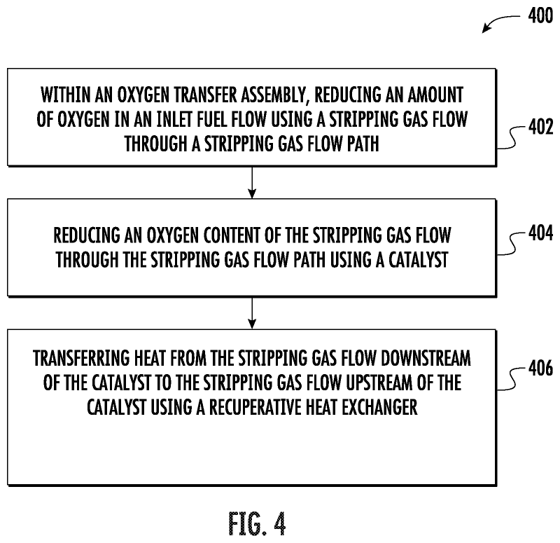

Referring now to FIG. 4, a method 400 for operating a fuel oxygen reduction unit for a fuel delivery system of a gas turbine engine is provided. In certain exemplary aspects, the method 400 may be utilized with one or more of the exemplary fuel delivery systems or fuel oxygen reduction units described above.

The method 400 includes at (402) within an oxygen transfer assembly, reducing an amount of oxygen in an inlet fuel flow using a stripping gas flow through a stripping gas flowpath as described in detail above with reference to FIGS. 1 through 3.

The method 400 further includes at (404) reducing an oxygen content of the stripping gas flow through the stripping gas flowpath using a catalyst as described in detail above with reference to FIGS. 1 through 3.

For the exemplary aspect depicted, the method 400 further includes at (406) transferring heat from the stripping gas flow downstream of the catalyst to the stripping gas flow upstream of the catalyst using a recuperative heat exchanger as described in detail above with reference to FIGS. 1 through 3.

Further aspects of the disclosure are provided by the subject matter of the following clauses:

A fuel oxygen reduction unit defining a stripping gas flowpath having a stripping gas flow provided therethrough during operation of the fuel oxygen reduction unit, the fuel oxygen reduction unit comprising: an inlet fuel line and an outlet fuel line; an oxygen transfer assembly in fluid communication with the inlet fuel line, the outlet fuel line, and the stripping gas flowpath for reducing an amount of oxygen in an inlet fuel flow through the inlet fuel line using the stripping gas flow through the stripping gas flowpath; a catalyst in airflow communication with the stripping gas flowpath at a location downstream of the oxygen transfer assembly, the catalyst configured to reduce an oxygen content of the stripping gas flow through the stripping gas flowpath; and a recuperative heat exchanger in airflow communication with the stripping gas flowpath at a location downstream of the catalyst and upstream of the catalyst for exchanging heat from the stripping gas flow flowing from the catalyst with the stripping gas flow flowing through the recuperative heat exchanger at the location upstream of the catalyst.

The fuel oxygen reduction unit of any preceding clause, wherein the stripping gas flow is configured to travel through the stripping gas flowpath from the oxygen transfer assembly, through the recuperative heat exchanger as a heat sink, through the catalyst, back through the recuperative heat exchanger as a heat source, and back to the oxygen transfer assembly.

The fuel oxygen reduction unit of any preceding clause, wherein the fuel oxygen reduction unit further comprises a pre-heater in thermal communication with the stripping gas flowpath upstream of the catalyst for heating the stripping gas flow provided to the catalyst.

The fuel oxygen reduction unit of any preceding clause, wherein the location of the recuperative heat exchanger is upstream of the pre-heater.

The fuel oxygen reduction unit of any preceding clause, wherein a temperature of the stripping gas flow traveling to the oxygen transfer assembly is lower than a temperature of the stripping gas flow traveling to the pre-heater.

The fuel oxygen reduction unit of any preceding clause, further comprising a compressor in airflow communication with the stripping gas flowpath at a location downstream of the oxygen transfer assembly and upstream of the heat exchanger.

The fuel oxygen reduction unit of any preceding clause, wherein the oxygen transfer assembly comprises: a contactor including a fuel inlet in fluid communication with the inlet fuel line for receiving the inlet fuel flow and a stripping gas inlet in fluid communication with the stripping gas flowpath for receiving an inlet stripping gas flow from the stripping gas flowpath, the contactor configured to form a fuel/gas mixture; and a separator including an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow to the stripping gas flowpath through the stripping gas outlet and the outlet fuel flow to the outlet fuel line through the fuel outlet.

The fuel oxygen reduction unit of any preceding clause, wherein the inlet stripping gas flow exits the recuperative heat exchanger and flows to the contactor.

The fuel oxygen reduction unit of any preceding clause, wherein the outlet fuel flow has a lower oxygen content than the inlet fuel flow, and wherein the outlet stripping gas flow has a higher oxygen content than the inlet stripping gas flow.

The fuel oxygen reduction unit of any preceding clause, wherein the catalyst removes oxygen from the stripping gas flow by chemically converting the oxygen in the outlet stripping gas flow into a water vapor and a carbon dioxide.

The fuel oxygen reduction unit of any preceding clause, wherein the fuel oxygen reduction unit recirculates the stripping gas flow.

A method for operating a fuel oxygen reduction unit for a fuel delivery system of a gas turbine engine, the method comprising: within an oxygen transfer assembly, reducing an amount of oxygen in an inlet fuel flow using a stripping gas flow through a stripping gas flowpath; reducing an oxygen content of the stripping gas flow through the stripping gas flowpath using a catalyst; and transferring heat from the stripping gas flow downstream of the catalyst to the stripping gas flow upstream of the catalyst using a recuperative heat exchanger.

The method of any preceding clause, further comprising: providing the stripping gas flow from the oxygen transfer assembly through a heat sink path of the recuperative heat exchanger to the catalyst; and providing the stripping gas flow from the catalyst through a heat source path of the recuperative heat exchanger to the oxygen transfer assembly.

The method of any preceding clause, wherein providing the stripping gas flow from the catalyst through the heat source path of the recuperative heat exchanger to the oxygen transfer assembly comprises reducing a temperature of the stripping gas flow from the catalyst to the oxygen transfer assembly.

The method of any preceding clause, wherein the fuel oxygen reduction unit further comprises a pre-heater in thermal communication with the stripping gas flowpath upstream of the catalyst, and wherein providing the stripping gas flow from the oxygen transfer assembly through the heat sink path of the recuperative heat exchanger to the catalyst further comprises providing the stripping gas from the recuperative heat exchanger to the pre-heater and from the pre-heater to the catalyst.

The method of any preceding clause, wherein reducing the amount of oxygen in the inlet fuel flow using the stripping gas flow through the stripping gas flowpath comprises: mixing the inlet fuel flow with the stripping gas flow from the stripping gas flowpath within a contactor to form a fuel/gas mixture; separating the fuel/gas mixture out within a separator into an outlet fuel flow and the stripping gas flow; providing the outlet fuel flow to an outlet fuel line from the separator; and providing the stripping gas flow back to the stripping gas flowpath from the separator.

The method of any preceding clause, wherein mixing the inlet fuel flow with the stripping gas flow within the contactor comprises receiving the stripping gas flow from the recuperative heat exchanger.

The method of any preceding clause, wherein the outlet fuel flow has a lower oxygen content than the inlet fuel flow, and wherein the stripping gas flow provided back to the stripping gas flowpath from the separator has a higher oxygen content than the stripping gas flow through the stripping gas flowpath immediately upstream of the contactor.

The method of any preceding clause, wherein reducing the oxygen content of the stripping gas flow through the stripping gas flowpath using the catalyst comprises removing oxygen from the stripping gas flow by chemically converting the oxygen in the outlet stripping gas flow into a water vapor and a carbon dioxide.

The method of any preceding clause, further comprising recirculating a stripping gas within the oxygen transfer assembly.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A method for operating a fuel oxygen reduction unit for a fuel delivery system of a gas turbine engine, the method comprising:
within an oxygen transfer assembly, reducing an amount of oxygen in an inlet fuel flow using a stripping gas flow through a stripping gas flowpath;
reducing an oxygen content of the stripping gas flow through the stripping gas flowpath using a catalyst; and
transferring heat from the stripping gas flow downstream of the catalyst to the stripping gas flow upstream of the catalyst using a recuperative heat exchanger.

2. The method of claim 1, further comprising:
providing the stripping gas flow from the oxygen transfer assembly through a heat sink path of the recuperative heat exchanger to the catalyst; and
providing the stripping gas flow from the catalyst through a heat source path of the recuperative heat exchanger to the oxygen transfer assembly.

3. The method of claim 2, wherein the recuperative heat exchanger is in airflow communication with the stripping gas flowpath at a location downstream of the catalyst and upstream of the catalyst for exchanging heat from a first stripping gas flow flowing from the catalyst with a second stripping gas flow flowing through the recuperative heat exchanger from the oxygen transfer assembly at the location upstream of the catalyst.

4. The method of claim 2, wherein providing the stripping gas flow from the catalyst through the heat source path of the recuperative heat exchanger to the oxygen transfer assembly comprises reducing a temperature of the stripping gas flow from the catalyst to the oxygen transfer assembly.

5. The method of claim 2, wherein the fuel oxygen reduction unit further comprises a pre-heater in thermal communication with the stripping gas flowpath upstream of the catalyst, and wherein providing the stripping gas flow from the oxygen transfer assembly through the heat sink path of the recuperative heat exchanger to the catalyst further comprises providing the stripping gas flow from the recuperative heat exchanger to the pre-heater and from the pre-heater to the catalyst.

6. The method of claim 1, wherein reducing the amount of oxygen in the inlet fuel flow using the stripping gas flow through the stripping gas flowpath comprises:
mixing the inlet fuel flow with the stripping gas flow from the stripping gas flowpath within a contactor to form a fuel/gas mixture;
separating the fuel/gas mixture out within a separator into an outlet fuel flow and the stripping gas flow;
providing the outlet fuel flow to an outlet fuel line from the separator; and
providing the stripping gas flow back to the stripping gas flowpath from the separator.

7. The method of claim 6, wherein mixing the inlet fuel flow with the stripping gas flow within the contactor comprises receiving the stripping gas flow from the recuperative heat exchanger.

8. The method of claim 7, wherein the outlet fuel flow has a lower oxygen content than the inlet fuel flow, and wherein the stripping gas flow provided back to the stripping gas flowpath from the separator has a higher oxygen content than the stripping gas flow through the stripping gas flowpath immediately upstream of the contactor.

9. The method of claim 6, wherein reducing the oxygen content of the stripping gas flow through the stripping gas flowpath using the catalyst comprises removing oxygen from the stripping gas flow by chemically converting the oxygen in the outlet stripping gas flow into a water vapor and a carbon dioxide.

10. The method of claim 2, further comprising:
recirculating a stripping gas within the oxygen transfer assembly.
